(19) United States
(12) Patent Application Publication
(10) Pub. No.: US 2020/0301371 A1
(43) Pub. Date: Sep. 24, 2020

(54) PORTABLE RADIO-CONTROLLED WATCH

(71) Applicant: CITIZEN WATCH CO., LTD.

(72) Inventors: Ken KITAMURA, Nishitokyo-shi, Tokyo (JP); Akira KATO, Tokorozawa-shi, Saitama (JP); Shuji NAKA, Fuchu-shi, Tokyo (JP); Yohsuke NOMA, Koshigaya-shi, Saitama (JP)

(21) Appl. No.: 16/088,072

(22) PCT Filed: Mar. 16, 2017
(86) PCT No.: PCT/JP2017/010765

§ 371 Date: Sep. 24, 2018

(30) Foreign Application Priority Data
Mar. 29, 2016 (JP) 2016-066527

(51) Int. Cl. G04G 17/06; G04G 21/04; G04R 60/08; G04R 60/10

(52) U.S. Cl. CPC G04G 17/06; G04R 60/10; G04R 60/08; G04G 21/04

(57) ABSTRACT

Provided is a portable radio-controlled watch including: an antenna electrode; a receiving circuit arranged on a circuit board; a pair of connection pins, each of which has one end contacting the antenna electrode, and which are arranged in parallel to each other; intermediate wiring, which is connected to another end of each of the pair of connection pins, and extends in a direction separating from a case body; and RF connection wiring, which connects the intermediate wiring and the receiving circuit to each other.

### TECHNICAL FIELD

The present invention relates to a portable radio-controlled watch configured to receive a signal from a satellite or the like.

### BACKGROUND ART

A portable radio-controlled watch configured to receive time information included in a signal transmitted from a satellite forming a global positioning system (GPS) or the like to correct the time has been put into practical use. An arrangement of an antenna for receiving radio waves and a method of feeding power to the antenna are determined so that required reception sensitivity can be obtained without impairing the function of the watch.

In FIGS. 3 of Patent Literature 1, there is disclosed a feed pin 44 configured to directly connect a feed part 402 mounted to an annular antenna body 40 to a circuit board 25 including a GPS reception unit 26. The feed pin passes through a main plate 38.

In FIG. 15 of Patent Literature 2, there is disclosed a coaxial pin configured to directly connect a circuit board 120 including a receiving portion to an antenna 110. The coaxial pin includes a power feeding pin 115 and a ground pin 117 surrounding the power feeding pin 115, and has a characteristic similar to that of a coaxial cable. The antenna 110 is created so as to operate with unbalanced feed.

### CITATION LIST

### Patent Literature

[PTL 1] JP 2014-163666 A

[PTL 2] JP 2015-207855 A

### SUMMARY OF INVENTION

### Technical Problem

When a pin is used to directly connect an antenna to aboard including a receiving circuit, and the antenna is mounted along an outer periphery of a watch glass, the pin is arranged right nearby a case body of the watch, and hence reception loss is increased. Meanwhile, when a coaxial pin is used to connect the antenna to the board in order to reduce the loss, the unbalanced feed is employed because of the coaxial pin, and hence it has been difficult to increase the reception sensitivity. For example, when the antenna is made compatible with the unbalanced feed, there is a problem in keeping the characteristic when a circularly polarized wave is received. Further, the coaxial pin has limitations on reducing its outer diameter in terms of its structure, and hence the design tends to be restricted.

The present invention has been made in view of the above-mentioned circumstances, and has an object to provide a portable radio-controlled watch having high reception sensitivity.

### Solution to Problem

(1) According to one embodiment of the present invention, there is provided a portable radio-controlled watch including: an antenna electrode; a receiving circuit arranged on a circuit board; a pair of connection pins, each of which has one end contacting the antenna electrode, and which are arranged in parallel to each other; intermediate wiring, which is connected to another end of each of the pair of connection pins, and extends in a direction separating from a case body; and RF connection wiring configured to connect the intermediate wiring and the receiving circuit to each other.

(2) In the portable radio-controlled watch according to Item (1), the intermediate wiring includes a balun circuit, and the RF connection wiring includes a coaxial line or a coaxial pin.

(3) In the portable radio-controlled watch according to Item (2), the intermediate wiring is arranged on an intermediate board, which is different from the circuit board, and the balun circuit is arranged on a surface of the intermediate board on an opposite side of the antenna electrode.

(4) In the portable radio-controlled watch according to Item (2) or (3), a metal member is prevented from being arranged between the balun circuit and the circuit board.

(5) The portable radio-controlled watch according to Item (4) further includes a non-conductive spacer arranged between the balun circuit and the circuit board.

(6) In the portable radio-controlled watch according to any one of Items (1) to (5), the case body has a cutout in a part of the case body opposed to the intermediate wiring.

(7) The portable radio-controlled watch according to any one of Items (1) to (6) further includes: a watch glass, which has a back surface on which the antenna electrode is arranged; and a bezel, into which the watch glass is fitted, and which is connected to the case body, and the bezel has a cutout in an inner peripheral surface of the bezel at a position through which the pair of connection pins pass.

(8) The portable radio-controlled watch according to Item (7) further includes an annular packing, which is arranged between the watch glass and the bezel, and has a cutout at a position corresponding to the cutout of the bezel.

(9) The portable radio-controlled watch according to any one of Items (1) to (8) further includes a dial trim ring, which is arranged between the watch glass and the circuit board, and includes a fixing portion configured to fix the pair of connection pins.

(10) The portable radio-controlled watch according to Item (9) further includes a holding member configured to hold the pair of connection pins in parallel to each other, and the dial trim ring includes a fixing portion configured to fix the holding member.

### Advantageous Effects of Invention

According to one embodiment of the present invention, the portable radio-controlled watch having high reception sensitivity can be provided.

### BRIEF DESCRIPTION OF DRAWINGS

FIG. 1 is a plan view for illustrating an example of a satellite radio-controlled wristwatch according to an embodiment of the present invention.

FIG. 2 is a sectional view taken along the line II-II of the satellite radio-controlled wristwatch illustrated in FIG. 1.

FIG. 3 is a plan view for illustrating a circuit board and a balun board included in the satellite radio-controlled wristwatch illustrated in FIG. 1.

FIG. 4 is a block diagram for illustrating the outline of a circuit configuration of the satellite radio-controlled wristwatch.

FIG. 5 is a partial enlarged view of a cross section illustrated in FIG. 2.

FIG. 6 is a partial plan view of a bezel and a dial trim ring included in the satellite radio-controlled wristwatch illustrated in FIG. 1.

FIG. 7 is a sectional view taken along the line VII-VII of the satellite radio-controlled wristwatch illustrated in FIG. 1.

FIG. 8 is a view for illustrating an example of a packing.

FIG. 9 is a partial enlarged view for illustrating an example of a conductive pin.

FIG. 10 is a partial enlarged view for illustrating another example of the conductive pin.

FIG. 11 is a partial sectional view for schematically illustrating another example of the satellite radio-controlled wristwatch.

FIG. 12 is a partial sectional view for illustrating another example of the satellite radio-controlled wristwatch.

FIG. 13 is a partial sectional view for illustrating another example of the satellite radio-controlled wristwatch.

### DESCRIPTION OF EMBODIMENTS

Now, an embodiment of the present invention is described in detail with reference to the drawings. In the following, a satellite radio-controlled wristwatch 1 according to the embodiment of the present invention is described. The satellite radio-controlled wristwatch 1 according to this embodiment is configured to receive satellite radio waves including time information, and measure its position or correct the time counted by itself with use of the time information included in the received satellite radio waves.

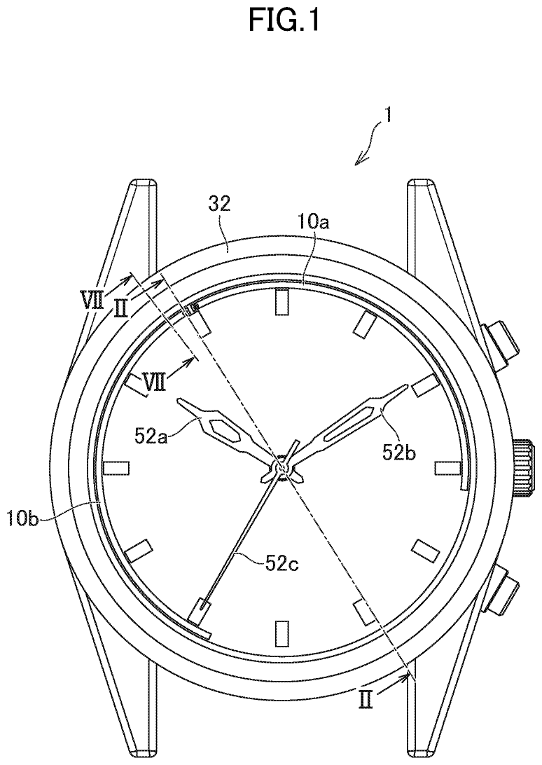

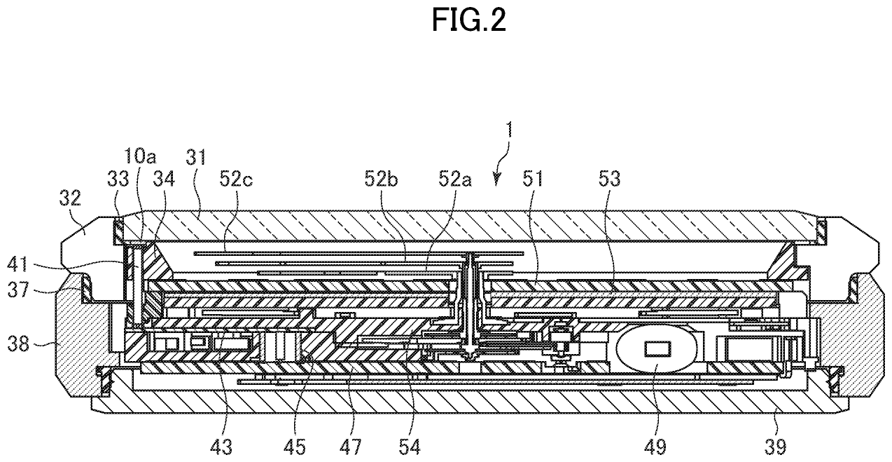

FIG. 1 is a plan view for illustrating an example of an outer appearance of the satellite radio-controlled wristwatch 1 according to the embodiment of the present invention, and FIG. 2 is a sectional view taken along the line II-II of the satellite radio-controlled wristwatch 1 illustrated in FIG. 1. As illustrated in FIG. 1 and FIG. 2, the satellite radio-controlled wristwatch 1 includes a watch glass 31, a bezel 32 for holding the watch glass 31, a cylindrical case body 38, and a back cover 39 mounted below the case body 38. Those components form an outer shape of the satellite radio-controlled wristwatch 1. The case body 38 and the bezel 32 are sandwiched between the watch glass 31 and the back cover 39. In the following, the direction from the center of the satellite radio-controlled wristwatch 1 toward the watch glass 31 is referred to as upward, and the direction toward the back cover 39 is referred to as downward.

The case body 38 is made of metal, and has upper and lower holes. The bezel 32 is a ring-shaped ceramic corresponding with a shape of the upper hole of the case body 38, and the bezel 32 is fitted into the upper hole to be connected to the case body 38. Further, the back cover 39 is made of metal, and has a flat surface corresponding with a shape of the lower hole of the case body 38. The back cover 39 is fitted into the lower hole. The watch glass 31 has a planar shape corresponding with a shape of an upper opening of the bezel 32, and is fitted into the opening of the bezel 32. The watch glass 31 and the bezel 32 are in contact with each other through intermediation of a packing 33, and the watch glass 31 is fixed by the packing 33. Further, the bezel 32 and the case body 38 are in contact with each other through intermediation of a packing 37, and the bezel 32 is fixed by the packing 37.

Further, the satellite radio-controlled wristwatch 1 includes antennas 10a and 10b, two conductive pins 41, a ring-shaped dial trim ring 34, a dial plate 51, an hour hand 52a, a minute hand 52b, a second hand 52c, a solar cell 53, a base plate 54, a balun board 43, a coaxial pin 45, a circuit board 47, and a motor 49. Those components are arranged in a space surrounded by the watch glass 31, the bezel 32, the case body 38, and the back cover 39.

The antennas 10a and 10b are arranged on the lower side (back side) of the watch glass 31 so as to extend along a peripheral edge of the watch glass 31. In the example of FIG. 1, each of the antennas 10a and 10b has an arc shape, and is bonded to the back side of the watch glass 31. Each of the antennas 10a and 10b receives a satellite signal transmitted from a satellite. In this embodiment, in particular, the antennas 10a and 10b are so-called dipole antennas, and receive radio waves having a frequency of about 1.6 GHz transmitted from a global positioning system (GPS) satellite. The GPS is one type of satellite positioning system, and is implemented by a plurality of GPS satellites orbiting around the earth.

The two conductive pins 41 correspond to the antennas 10a and 10b on a one-by-one basis, and each of the antennas 10a and 10b is electrically connected to the balun board 43 by the corresponding conductive pin 41. Upper ends of the two conductive pins 41 contact the antennas 10a and 10b, respectively. Further, lower ends of the two conductive pins 41 are in contact with two connection terminals, respectively, which are formed on the balun board 43. The positions of the conductive pins 41 in plan view are fixed by the dial trim ring 34, and the two conductive pins 41 are arranged in parallel to each other. In the example of FIG. 2, the conductive pins 41 are fixed in holes passing through the dial trim ring 34 in the up-down direction. As viewed from the antennas 10a and 10b, the conductive pins 41 extend in a direction separating from the watch glass 31.

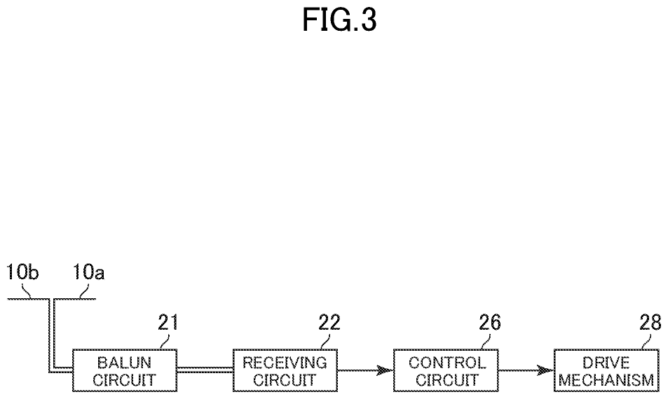

FIG. 3 is a block diagram for illustrating the outline of a circuit configuration of the satellite radio-controlled wristwatch 1. A balun circuit 21 converts signals received by the antennas 10a and 10b in order to connect balanced antennas such as dipole antennas to the coaxial pin 45 and a receiving circuit 22, which have an unbalanced characteristic. The receiving circuit 22 is connected to the balun circuit 21 via the coaxial pin 45. The receiving circuit 22 decodes the signals received by the antennas 10a and 10b to output a bit string (reception data) indicating the details of a satellite signal obtained as a result of decoding. More specifically, the receiving circuit 22 includes a high frequency circuit (RF circuit) and a decoder circuit. The high frequency circuit operates at a high frequency to amplify and detect the analog signals received by the antennas 10a and 10b and convert the signals to a baseband signal. The decoder circuit decodes the baseband signal output from the high frequency circuit, and generates a bit string indicating the details of the data received from the GPS satellite to output the bit string to a control circuit 26.

The control circuit 26 is a circuit configured to control various circuits and mechanisms included in the satellite radio-controlled wristwatch 1, and includes, for example, a microcomputer, a motor drive circuit, and a real time clock (RTC). The control circuit 26 acquires the time based on the reception data or a clock output by the RTC to drive the motor 49 included in a drive mechanism 28 in accordance with the acquired time. The drive mechanism 28 includes the motor 49 being a stepper motor and a gear train. The motor 49 is mounted on a surface of the circuit board 47 on the dial plate 51 side. The gear train transmits the rotation of the motor 49 to rotate any one of the hour hand 52a, the minute hand 52b, and the second hand 52c, for example. The current time is indicated in this manner.

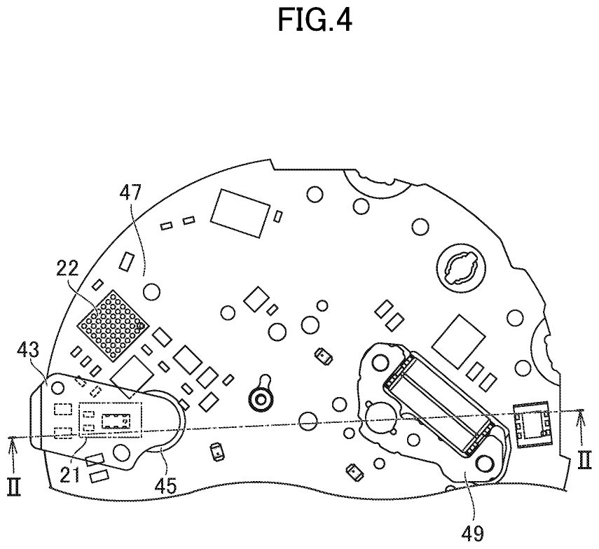

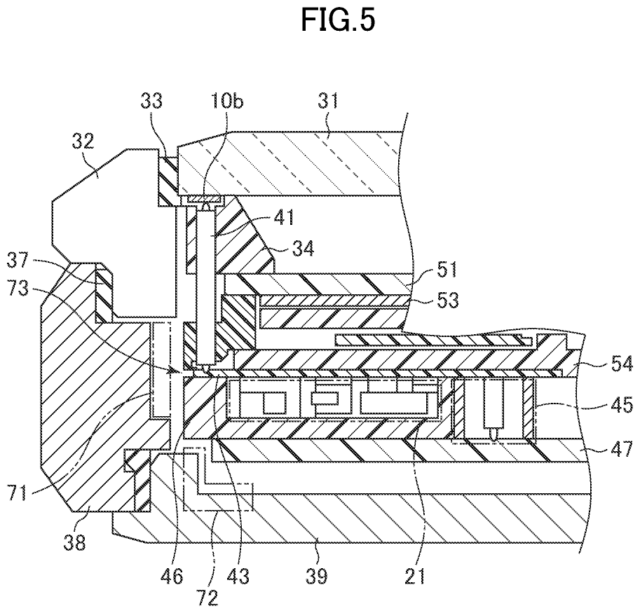

Next, the arrangement of the balun circuit 21, the receiving circuit 22, and the like is described. FIG. 4 is a plan view for illustrating the circuit board 47 and the balun board 43 included in the satellite radio-controlled wristwatch 1 illustrated in FIG. 1. The line II-II illustrated in FIG. 4 corresponds to the cross section illustrated in FIG. 2. Further, FIG. 5 is a partial enlarged view of the cross section illustrated in FIG. 2. The balun board 43 is arranged on the circuit board 47. On a lower surface of the balun board 43, the balun circuit 21 connected to the antennas 10a and 10b is arranged, and the receiving circuit 22 is arranged on the circuit board 47. In the example of FIG. 4, in plan view, the receiving circuit 22 is arranged adjacent to the balun board 43. The balun board 43 does not overlap with the motor 49 or a battery in plan view.

A non-conductive spacer 46 made of, for example, resin is arranged between the balun board 43 and the circuit board 47, and an interval is maintained between the balun board 43 and the circuit board 47 by the spacer 46. The balun board 43 and the circuit board 47 are arranged in parallel to each other. The spacer 46 is present between the balun circuit 21 and the circuit board 47, but no metal member, for example, GND wiring, is arranged therebetween. The spacer 46 is fixed to the base plate 54. Further, an opening 73 of a movement is present so as to be adjacent to an end portion of the balun board 43 on the case body 38 side, and the spacer 46 is not present between the balun board 43 and the case body 38. The solar cell 53 is arranged right below the dial plate 51, and the base plate 54 and the like are arranged between the solar cell 53 and the balun board 43 or the circuit board 47.

The antennas 10a and 10b and the balun circuit 21 are connected to each other by the conductive pins 41 and intermediate wiring on the balun board 43. The intermediate wiring is wiring extending on the balun board 43 from connection terminals for the conductive pins 41. The intermediate wiring extends away from the case body 38 as viewed from the connection terminals. Further, the balun circuit 21 and the receiving circuit 22 are connected to each other by RF connection wiring. The RF connection wiring includes the coaxial pin 45, wiring on the balun board 43 connecting the coaxial pin 45 and the balun circuit 21 to each other, and wiring on the circuit board 47 connecting the coaxial pin 45 and the receiving circuit 22 to each other. The coaxial pin 45 electrically connects the wiring on the balun board 43 and the wiring on the circuit board 47 to each other. The coaxial pin 45 is closer to the center of the dial plate 51 as compared to the conductive pins 41 in plan view, and is further away from the case body 38 than the conductive pins 41. The conductive pins 41, the intermediate wiring, the balun circuit 21, and the RF connection wiring form a connection circuit configured to connect the antennas 10a and 10b and the receiving circuit 22 to each other. Further, the conductive pins 41 are a type of wiring connecting the antennas 10a and 10b and the balun circuit 21 to each other.

A coaxial line, for example, a coaxial cable, may be used instead of the coaxial pin 45. Further, without arranging the balun circuit 21 on the balun board 43, the conductive pins 41 and the coaxial pin 45 may be connected to each other by the intermediate wiring. Further, without providing the balun circuit 21, there may be provided intermediate wiring, which is separated from the circuit board 47, which is in contact with the conductive pins 41 at the position on the watch glass 31 side, and which extends to be away from the case body 38 to be connected to the circuit board 47.

A metal member is prevented from being arranged in the vicinity of the conductive pins 41 as much as possible, and the intermediate wiring on the balun board 43 extends so as to separate from the metal case body 38. Further, the coaxial pin 45 is arranged at a further inner position. In this manner, paths of the signals received by the antennas 10a and 10b are separated from the metal, to thereby reduce the influence on reception sensitivity by the metal. Further, in the example illustrated in FIG. 5, a reception signal is transmitted between the antennas 10a and 10b and the balun board 43 by the non-coaxial conductive pins 41, and a reception signal is transmitted between the balun board 43 and the circuit board 47 by the coaxial pin 45. When the conductive pins 41 are formed of coaxial pins, not only a problem in difference between balanced and unbalanced characteristics occurs, but also the design of components is more restricted due to the thick pins. In this embodiment, the non-coaxial conductive pins 41 are used to reduce the restrictions on design. Impedances of the conductive pins 41 are suitably adjusted by an interval between the two conductive pins 41. Meanwhile, the coaxial pin 45 can reduce the influence of noise from the receiving circuit 22 and the microcomputer with the coaxial structure. As described above, different types of conductive pins are used depending on position to achieve both the sensitivity and flexibility in design. When the balun board 43 is arranged between the circuit board 47 and the dial plate 51, an interval between the circuit board 47 and the dial plate 51 is increased, but when the motor 49 is arranged on the surface of the circuit board 47 on the dial plate 51 side, a distance between the motor 49 and the dial plate 51 can be rather reduced.

Further, as illustrated in FIG. 5, the case body 38 has a cutout 71 in a part thereof opposing to the conductive pins 41 and the intermediate wiring. With this cutout 71, a distance between the metal case body 38 and the conductive pins 41 or the intermediate wiring is increased, and thus reduction in sensitivity due to the influence of an external metal with respect to the wiring from the antennas 10a and 10b can be suppressed. Further, in the back cover 39, a cutout may be formed in a region 72 overlapping with the conductive pins 41 in plan view.

The spacer 46 between the balun board 43 and the circuit board 47 may be, for example, a dielectric having a high permittivity, for example, a ceramic. For example, a ceramic having a permittivity of from 10 to 90 can be employed as the spacer 46. Further, the permittivity of the spacer 46 is only required to be equivalent to or larger than that of the dielectric arranged around the spacer 46. As the spacer 46, a resin or other dielectrics having a permittivity of 10 or less, or another material having a permittivity of 90 or more may be employed. When a substance having a high permittivity is arranged between metal and a reception signal path, an adverse effect of metal or the like with respect to the high-frequency reception signal can be suppressed. Therefore, when the spacer 46 is a dielectric, the influence on the reception signal by the metal back cover 39 or the like can be further reduced. The spacer 46 may be an integrally-molded ceramic member. Further, the spacer 46 may include a ceramic member (high dielectric member) covering the balun circuit 21 and the wiring related to the balun circuit 21 from the lower side, and a resin member fixed to the base plate 54 or the like to hold the high dielectric member.

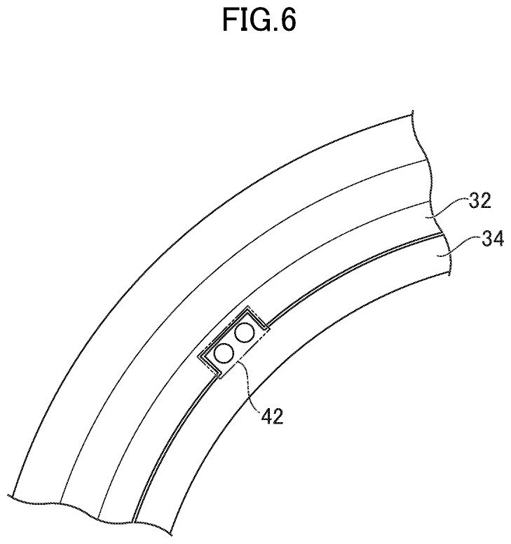

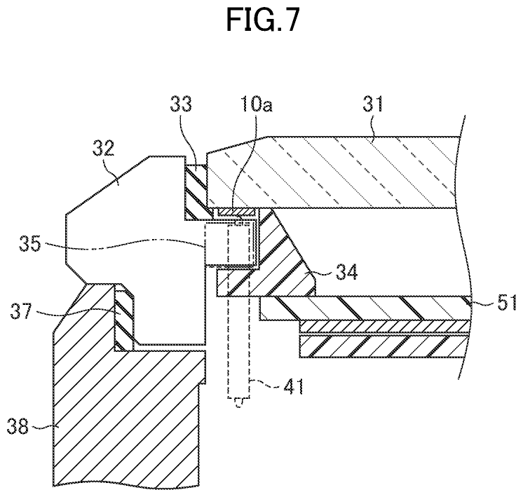

Further, the bezel 32 has a cutout 42 in an inner peripheral surface thereof at a position through which the conductive pins 41 pass. FIG. 6 is a partial plan view of the bezel 32 and the dial trim ring 34. In plan view, the bezel 32 has a part on the outer side of the peripheral edge of the watch glass 31, and a protruding portion 35 (see FIG. 7) protruding from the outer-side part toward the inner side. The cutout 42 is formed in the protruding portion 35 in the vicinity of the conductive pins 41. In plan view, the dial trim ring 34 is present on the inner peripheral side of the bezel 32 at the position of the cutout 42, and two holes serving as structures for fixing the conductive pins 41 are formed in a region of the dial trim ring 34 overlapping with the cutout 42. Further, the two conductive pins 41 are arranged so as to pass through the two holes.

The two conductive pins 41 may be held in parallel by a holding member fixed by the dial trim ring 34. In this case, as the structure for fixing the conductive pins 41, a structure (hole) for fixing the holding member is formed in the dial trim ring 34. Further, the holding member may be created by injecting resin in a mold in which the conductive pins 41 are arranged (insert molding). Further, the two conductive pins 41 may be fixed by a structure provided on the dial plate 51, the base plate 54, or other members.

When the holes for allowing passage of the conductive pins 41 are formed in the dielectric bezel 32, a certain thickness is required around the holes in order to ensure the strength, and hence there are restrictions on the size of the protruding portion 35 and the positions of the holes. Meanwhile, when the cutout 42 is formed in the bezel 32 and the conductive pins 41 are held by the resin dial trim ring 34, there are less restrictions on the positions of the holes as compared to the case described above, and the holes for holding the conductive pins 41 can be made closer to the outer peripheral edge (outer side) of the watch glass 31. As the conductive pins 41 are positioned further outward, the antennas 10a and 10b can also be mounted closer to the outer side of the watch glass 31, and thus the antennas 10a and 10b can be made inconspicuous easily.

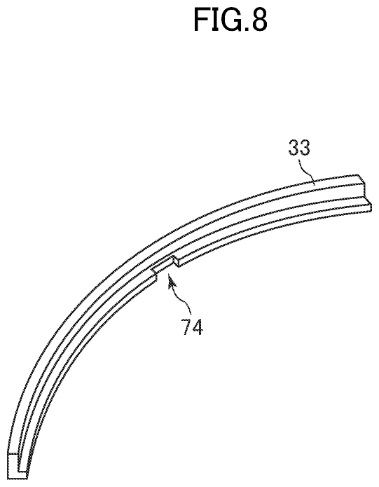

FIG. 8 is a view for illustrating an example of the packing 33. In FIG. 8, for simplification of the description, only a part of the annular packing 33 is illustrated. The annular packing 33 mounted along the inner periphery of the protruding portion 35 of the bezel has a cutout 74 at a position corresponding to the cutout 42. The cutout 74 of the packing 33 is formed at a position opposing to the conductive pins 41, and the sectional area of the packing 33 is reduced at a position at which the cutout 74 is formed. With the cutout 74 of the packing 33, the packing 33 can be prevented from interfering with the conductive pins 41 even when the packing 33 is pressed against the inner peripheral edge of the protruding portion 35 at the time of fitting of the watch glass 31.

Next, relationships between the antennas 10a and 10b and peripheral members are described in more detail. FIG. 7 is a sectional view taken along the line VII-VII of the satellite radio-controlled wristwatch 1 illustrated in FIG. 1. In FIG. 7, the conductive pins 41 are not present on the cross section, and are indicated by the broken line in FIG. 7. In FIG. 7, there is a certain horizontal distance from the conductive pins 41, and hence the cutout 71 is not illustrated in the cross section of the case body 38.

The bezel 32 is made of a ceramic being a dielectric, and the protruding portion 35 covers at least a part of the antennas 10a and 10b present at the peripheral edge of the watch glass 31 in plan view. The protruding portion 35 is arranged right below at least a part of the antennas 10a and 10b, and has a shape of a ring with a cutout. In the example of this embodiment, the protruding portion 35 is arranged right below a part of the antennas 10a and 10b except for a part connected to the conductive pins 41. Further, the dial trim ring 34 is made of an insulating resin, and is arranged adjacent to the inner periphery of the bezel 32. Further, the dial trim ring 34 is also arranged below the protruding portion 35 so as to be adjacent thereto.

In this embodiment, the dielectric (bezel 32 in this case) below the antennas 10a and 10b provides a wavelength shortening effect, and the reduction in sensitivity by the dielectric is suppressed by directly connecting the conductive pins 41 to the antennas 10a and 10b. In this manner, as compared to the case in which those configurations are not included, the satellite radio-controlled wristwatch 1 can be more thinned and have higher sensitivity.

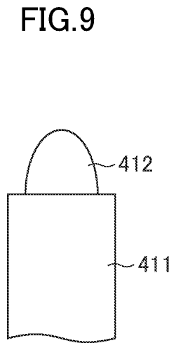

Now, the conductive pins 41, which contact the antennas 10a and 10b, are described in further detail. FIG. 9 is a partial enlarged view for illustrating an example of the conductive pin 41. The conductive pin 41 is a so-called probe pin, and includes a cylindrical portion 411 and an end portion 412. The end portion 412 is inserted into the cylindrical portion 411, and a tip end of the end portion 412 is protruded from an end of the cylindrical portion 411. Further, a spring is provided inside the cylindrical portion 411 to press the end portion 412 outward. In this manner, the electrical connection is maintained even when the arrangement between the antennas 10a and 10b and the conductive pins 41 slightly changes. In this case, the same structure as that illustrated in FIG. 9 is provided also at an end of the conductive pin 41 on the opposite side, and the end portions 412 at both ends of the conductive pin 4l are movable. In this manner, the possibility of causing electrical connection failure by the problem of extension/contraction of the end portion 412 can be reduced.

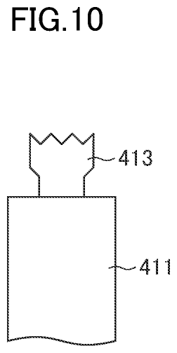

The conductive pin 41 may have another shape. FIG. 10 is a partial enlarged view for illustrating another example of the conductive pin 41. In the example of FIG. 10, unlike the example of FIG. 9, a tip end of an end portion 413 is formed to have a plurality of contact points with a surface of the antenna 10a or 10b or another conductor. More specifically, in the example of FIG. 10, the tip end of the end portion 413 has a plurality of protrusions. In this manner, two or more contact points are provided between the tip end of the end portion 413 and another conductor, and thus the possibility of causing connection failure can be reduced.

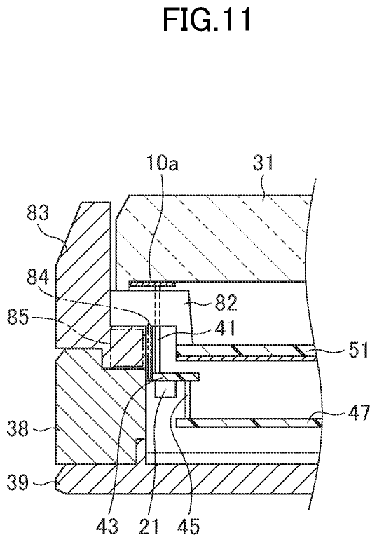

In this case, the bezel 32 may include a part made of metal. FIG. 11 is a partial sectional view for schematically illustrating another example of the satellite radio-controlled wristwatch 1, and is a view for illustrating a cross section corresponding to FIG. 7. In the example of FIG. 11, unlike the example illustrated in FIG. 7, the bezel 32 includes a dielectric portion 82, which is made of a ceramic or other dielectrics and is integrated with the dial trim ring, and a metal portion 83 made of metal. Further, the dielectric portion 82 is also integrated with an auxiliary member 84 present below. The metal portion 83 is fitted into the case body 38 to be arranged on the outer peripheral side of the bezel 32, and includes, at a lower portion, a protruding portion 85, which protrudes toward the inner peripheral side and has an upper surface supporting the dielectric portion 82. The dielectric portion 82 has a ring shape, and its cross section has a rectangular part and a trapezoidal part that is connected to the rectangular part and has a slope corresponding to the dial trim ring. The rectangular part overlaps with the antennas 10a and 10b in plan view.

In the example of FIG. 11, a lower surface of a part of the watch glass 31 on the outer side of the antennas 10a and 10b is lower than a lower surface of other regions, and is in contact with an upper surface of the dielectric portion 82. In this manner, the watch glass 31 can be mounted close to also a horizontal outer side (metal portion 83 side) of the antennas 10a and 10b. Therefore, the wavelength shortening effect by the permittivity of the watch glass 31 can be increased, and the radio wave reception sensitivity can be improved. Further, the balun circuit 21 and the circuit board 47 are prevented from overlapping with each other in plan view, and hence the noise from the circuit board 47 can be prevented from entering the balun circuit 21.

The auxiliary member 84 is an annular member mounted so as to cover an inner peripheral surface of the protruding portion 85, and is present between the conductive pins 41 and the metal portion 83 of the bezel 32. The auxiliary member 84 is a dielectric, and can reduce the influence caused by the metal portion 83 on signals flowing through the conductive pins 41. The auxiliary member 84 may be separated from the dielectric portion 82. Further, the auxiliary member 84 may only cover a part of the inner peripheral surface of the protruding portion 85 that is opposed to the conductive pins 41.

When a part of the bezel 32 close to the antennas 10a and 10b is made of dielectrics such as a ceramic, resistance against impact of the satellite radio-controlled wristwatch 1 can be improved by the part of the bezel 32 made of metal while the satellite radio-controlled wristwatch 1 is increased in sensitivity and reduced in thickness. In particular, two characteristics of high sensitivity and impact resistance can coexist.

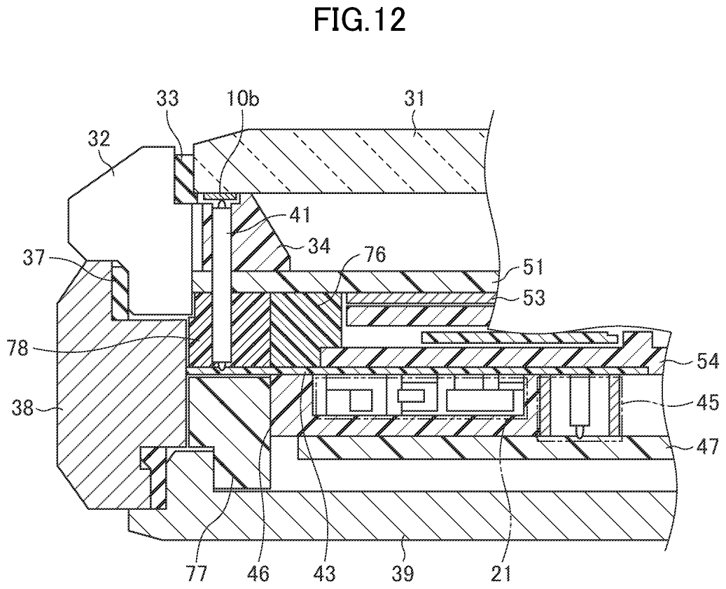

FIG. 12 is a partial sectional view for illustrating another example of the satellite radio-controlled wristwatch 1, and is a view corresponding to FIG. 5. In the example of FIG. 12, as compared to the example of FIG. 5, the size of the satellite radio-controlled wristwatch 1 is increased, but a size of a movement including the circuit board 47 and the motor 49 is not changed. Ring-shaped spacers 77 and 78 are mounted between the movement and the case body 38. The ring-shaped spacer 77 is arranged between the back cover 39 and the balun board 43 as viewed in the up-down direction, and the ring-shaped spacer 78 is arranged between the balun board 43 and the dial plate 51 as viewed in the up-down direction. The antennas 10a and 10b are mounted to the peripheral edge of the watch glass 31 as in the example of FIG. 5.

The balun board 43 extends to exceed the position corresponding to the opening 73 in FIG. 5 to reach the vicinity of the case body 38. On the inner side of the movement, the balun board 43 is sandwiched between spacers 46 and 76, which overlap with the circuit board 47 in plan view. In this case, the spacer 46 is present between the balun board 43 and the circuit board 47, and the spacer 76 is present between the balun board 43 and the dial plate 51. Further, in plan view, a region of the balun board 43 on the case body 38 side of the circuit board 47 and the spacers 46 and 76 is fixed by the ring-shaped spacers 77 and 78. The ring-shaped spacer 78 has holes for allowing the conductive pins 41 to pass therethrough. Further, as in the example of FIG. 5, the balun board 43 extends outward of the outer periphery of the circuit board 47.

As illustrated in FIG. 12, the balun board 43 extends to the outside of the movement. Thus, even when the size of the satellite radio-controlled wristwatch 1 is increased, and the conductive pins 41 right below the antennas 10a and 10b present in the peripheral edge of the watch glass 31 do not overlap with the circuit board 47 in plan view, it is possible to respond to the change by only changing the length of the balun board 43. In this manner, the satellite radio-controlled wristwatch 1 can be manufactured in various sizes without greatly changing the interior of the movement. Further, the ring-shaped spacers 77 and 78 are used not only for the fixation of a planar position of the movement but also for fixation of the balun board 43 in the up-down direction, and hence the structure can be simplified. The spacer 76 and the ring-shaped spacer 78 may be connected to and integrated with each other.

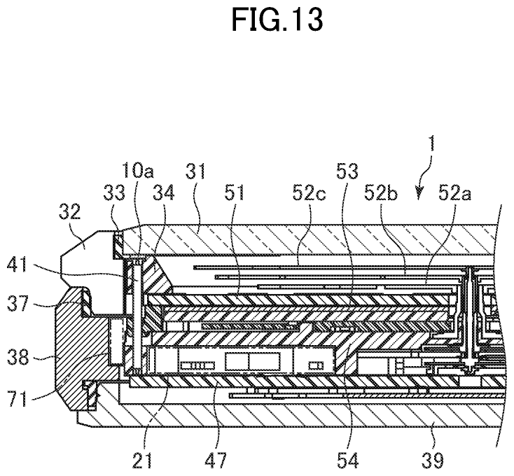

FIG. 13 is a partial sectional view for schematically illustrating another example of the satellite radio-controlled wristwatch 1, and is a view corresponding to FIG. 2 and FIG. 5. In the example of FIG. 13, the configuration of the part except for the circuit board 47 and the balun board 43 is the same as that in the example of FIG. 2 and FIG. 5. Also in the example of FIG. 13, the bezel 32 has the cutout 42, and the packing 33 has the cutout 74. Further, the dial trim ring 34 has the structure for fixing the conductive pins 41. Meanwhile, in the example of FIG. 13, the conductive pins 41 are in contact with the circuit board 47, and the intermediate wiring and the balun circuit 21 are mounted on the circuit board 47. Therefore, as compared to the example of FIG. 2 and the like, the conductive pins 41 are susceptible to the case body 38, but the cutout 71 of the case body 38 or the like can reduce the influence to obtain practical sensitivity. Also in the example of FIG. 13, the bezel 32, the packing 33, and other structures enable the conductive pins 41 to be brought closer to the peripheral edge side of the watch glass 31, and the antennas 10a and 10b can be made inconspicuous.

A case, in which the present invention is applied to the satellite radio-controlled wristwatch 1, has been described so far, but the present invention is also applicable to, for example, a portable small-sized watch that is not a wristwatch.

The invention claimed is:

1: A portable radio-controlled watch, comprising:
a piece of watch glass;
an antenna electrode;
a receiving circuit arranged on a circuit board;
an intermediate board, which is different from the circuit board, and on which intermediate wiring extending in a direction separating from a case body is arranged;
a connection pin, which has one end contacting the antenna electrode, and has another end connected to the intermediate wiring; and
RF connection wiring configured to connect the intermediate wiring and the receiving circuit to each other.

2: The portable radio-controlled watch according to claim 1,
wherein the intermediate wiring includes a balun circuit, and
wherein the RF connection wiring includes a coaxial line or a coaxial pin.

3: The portable radio-controlled watch according to claim 2, wherein the balun circuit is arranged on a surface of the intermediate board on an opposite side of the antenna electrode.

4: The portable radio-controlled watch according to claim 2, wherein a metal member is prevented from being arranged between the balun circuit and the circuit board.

5: The portable radio-controlled watch according to claim 4, further comprising a non-conductive spacer arranged between the balun circuit and the circuit board.

6: The portable radio-controlled watch according to claim 1, wherein the case body has a cutout in a part of the case body opposed to the intermediate wiring.

7: The portable radio-controlled watch according to claim 1, further comprising a bezel, into which the piece of watch glass is fitted, and which is connected to the case body,
wherein the antenna electrode is arranged on a back surface of the piece of watch glass, and
wherein the bezel has a cutout in an inner peripheral surface of the bezel at a position through which the connection pin passes.

8: The portable radio-controlled watch according to claim 7, further comprising an annular packing, which is arranged between the piece of watch glass and the bezel, and has a cutout at a position corresponding to the cutout of the bezel.

9: The portable radio-controlled watch according to claim 1, further comprising a dial trim ring, which is arranged between the piece of watch glass and the intermediate board, and includes a fixing portion configured to fix the connection pin.

10: The portable radio-controlled watch according to claim 9, further comprising a holding member configured to hold the connection pin and another connection pin in parallel to each other,
wherein the dial trim ring includes a fixing portion configured to fix the holding member.
